(19) United States
(12) Patent Application Publication
(10) Pub. No.: US 2007/0252529 A1
(43) Pub. Date: Nov. 1, 2007

(54) Capacitively Coupled Rf-Plasma Reactor

(75) Inventor: Andy Belinger, Azmoos (CH)

Correspondence Address: PEARNE & GORDON LLP, 1801 EAST 9TH STREET, SUITE 1200, CLEVELAND, OH, 44114-3108, US

(73) Assignee: OC OERLIKON BALZERS AG, Balzers (LI)

(21) Appl. No.: 11/719,115

(22) PCT Filed: Nov. 11, 2005
(86) PCT No.: PCT/CH05/00669

§ 371 Date: Jul. 6, 2007

Related U.S. Application Data
(60) Provisional application No. 60/627,784, filed on Nov. 12, 2004.

(51) Int. Cl. H05H 1/24

(52) U.S. Cl. 315/111.21

(57) ABSTRACT

An RF plasma reactor is provided for depositing semi-conductive layers on to very large glass areas. The RF plasma reactor includes a vacuum chamber, a reactor chamber, RF power supply, a matching network, first and second metallic plates located inside the vacuum chamber and a plasma-discharge region defined between the first and second metallic plates. The RF plasma reactor further includes a feed line and an impedance-transformation circuit both of which are electrically connected to the first metallic plate. The impedance-transformation circuit further includes a blocking-tuneable capacitor that transforms an impedance of the reactor.

This application claims the benefit of U.S. Provisional Patent Application No. 60/627,784 filed on Nov. 12, 2004.

### FIELD OF THE INVENTION

The present invention relates in general to RF capacitive coupled plasma reactors for processing a very large area display. More specifically, the present invention relates to improvements in the coupling efficiency of the RF power delivered to plasma typically at a frequency of 13.56 MHz or less.

### BACKGROUND OF THE INVENTION

The present invention is based on problems and requirements that have arisen in depositing semi-conductive layers on very large glass areas for the display and solar manufacturing industries. The resulting solution, however, can be applied to other applications. Thus, even though the present invention will be described relating to plasma reactors for Plasma Enhanced Chemical Vapor Deposition (PECVD) systems for very large area display processing, the present invention can also be applied to other applications relating to plasma reactors. Further, the development of PECVD for very large area display processing is disclosed in U.S. Pat. No. 6,281,469, the contents of which are herein incorporated by reference.

FIG. 1 shows a conventional capacitively-coupled, RF-plasma reactor system 10 for a PECVD system. The reactor system 10 includes an RF power supply 12, a matching network 14, a reactor chamber 16, and a vacuum chamber 18. The reactor chamber 16 includes two metallic plates 20, 22 arranged in parallel enclosed in a metallic-reactor casing 24. The first metallic plate 22 is electrically connected to the RF power supply 12 via a feeding element 26 and the matching network 14 and the first metallic plate 22 is, thus, a live electrode. The second metallic plate 20 is connected to ground and is, thus, a ground electrode. During the deposition process a substrate is placed on the second metallic plate 20 for processing. The feeding element 26 is shielded with a grounding shield 28 and can be any type of electrical feeding element known in the art, such as an RF stripline, RF ribbon, or a triplate stripline. A plasma-discharge region 30 is defined in between the two metallic plates 20, 22. As shown in FIG. 1, the RF power supply 12 and matching network 14 are located outside the vacuum chamber 18 and the reactor chamber 16 and feeding element 26 are located inside the vacuum chamber 18. Thus, during the deposition process, the RF power supply 12 and the matching network 14 are under atmospheric conditions and the reactor chamber 16 and RF feed line 28 are under vacuum conditions. A typical gas used for forming a plasma in the PECVD process is a silicon nitride SiN gas. Other gases commonly known in the art, however, may be used in this type of application such as organometallics, hydrides and halides.

FIG. 2 shows a simplified equivalent circuit of the conventional PECVD system during the deposition of SiN and will be used to illustrate the disadvantage of the conventional RF-plasma reactor system 10. The dotted line boxes represent a portion of the conventional RF-plasma reactor system 10 as indicated by the reference numbers. During the deposition process, in the conventional RF-plasma reactor, several kilowatts of RF power at a radio frequency of 13.56 MHz must be delivered to the plasma in order to achieve the necessary deposition rate and maintain a reasonable throughput. A disadvantage to this process in large area parallel plate reactors is that a very large parasitic-reactor capacitance C_{R}, typically greater than 5000 pF, forms between the live electrode 22 and the grounded reactor casing 24. Thus, the feeding element 26 must be capable of handling very large RF currents I_{F}, typically greater than 300 A. The large RF currents require a very wide stripline design, which leads to a second parasitic-feed-line capacitance C_{F} between the live wire of the feeding element 26 and the grounding shield 28. The feed-line capacitance C_{F} is typically greater than 3000 pF. The reactor C_{R} and feed-line C_{F} capacitance transform a plasma impedance Z_{P} to a feed-through impedance Re(Z_{F}) having a very small value, typically less than 0.05 ohms. The feed-through impedance Re(Z_{F}) is the impedance as seen at the entrance of the vacuum chamber 18 where the feeding element 26 enters the vacuum chamber 18. The feed-through impedance Re(Z_{F}) in turn creates a larger RF current I_{F}, typically greater than 400 A, which now must be accommodated by the matching network 14 and the feeding element 26. As a result, most of the power delivered by the RF power supply is dissipated in the lossy elements R_{M}, R_{F} of the matching network 14 and the feeding element 26 respectively. Thus, the efficiency of the system is low, typically ηs<0.3. Therefore, very large and expensive RF power supplies are required in order to achieve the necessary plasma power density and deposition rate. Further, as the size of the glass increases the efficiency of the plasma power coupling efficiency decreases to values less than 20% at an RF frequency of 13.56 MHz.

There have been several solutions to address the above mentioned problem but each have additional disadvantages. For example, the parasitic capacitance C_{R} and C_{F} could be reduced by increasing the gap between the live parts, i.e. the live electrode 22 and feeding element 26, and the grounded parts, i.e. the reactor casing 24 and the ground shield 28. The disadvantage to this solution, however, is that the plasma between the gaps could ignite. Another solution is to water cool the reactor. This, however, is difficult in a vacuum system and water cooling does not significantly enhance the plasma coupling efficiency.

Another solution is adding an impedance-transformation circuit to the RF-plasma reactor system 10. Power losses through the lossy elements R_{M}, R_{F} in the matching network 14 and the feeding element 26 respectively can be reduced by decreasing the RF current I_{F}. Reducing the RF current I_{F} while maintaining the plasma power can be accomplished with an impedance-transformation circuit, which increases the feed-through impedance Re(Z_{F}). In theory, connecting an inductor between the live electrode and ground will suffice as an impedance-transformation circuit. But an impedance-transformation circuit solely made of one inductor is impractical for several reasons. For example, the inductor needs to be a low-loss inductor, there is nothing to prevent the DC voltage from shorting to ground, and there is no tuning capability.

Thus, what is desired is a practical impedance-transformation circuit for an RF capacitive coupled plasma reactor for processing very large substrates that overcomes the above mentioned disadvantages.

### BRIEF SUMMARY OF THE INVENTION

In accordance with one aspect of the present invention, a plasma reactor is provided comprising, a vacuum chamber, a first metallic plate and a second metallic plate located inside the vacuum chamber, an RF power supply, a matching network, a plasma-discharge region containing plasma defined between the first and second metallic plates, a feeding element electrically connected to the first metallic plate, and an impedance-transformation circuit electrically connected to the first metallic plate.

In accordance with another aspect of the present invention, a plasma reactor is provided comprising, a vacuum chamber, an RF power supply, a matching network, a first metallic plate and a second metallic plate located inside the vacuum chamber, a plasma-discharge region for containing plasma defined between the first and second metallic plates, a feeding element electrically connected to the first metallic plate, an impedance-transformation circuit electrically connected to the first metallic plate, comprising an isolation capacitor, later referred as blocking capacitor.

In accordance with yet another aspect of the present invention a method of depositing semi-conductive layers in a vacuum is provided comprising the steps of, providing a plasma reactor further including an RF power supply, a vacuum chamber, a reactor chamber, having a reactor impedance, located inside the vacuum chamber, a first and second metallic plate located inside the vacuum chamber; a plasma-discharge region for containing plasma defined between the first and second metallic plates, a feeding element electrically connected to the first metallic plate, and an impedance-transformation circuit electrically connected to the first metallic plate, placing a substrate on the second metallic plate, delivering RF power to the plasma, transforming the reactor impedance to an intermediate impedance with the impedance-transformation circuit, and transforming the intermediate impedance to a feed-through impedance with the feeding element, whereby the feed-through impedance is increased.

Additional benefits and advantages of the present invention will become apparent to those skilled in the art to which it pertains upon a reading and understanding of the following detailed specification.

### BRIEF DESCRIPTION OF THE DRAWINGS

The invention may take physical form in certain parts and arrangement of parts, a preferred embodiment of which will be described in detail in this specification and illustrated in the accompanying drawings that form a part of the specification.

FIG. 1 is a schematic of a conventional capacitor-coupled, RF-plasma reactor system.

FIG. 2 is an equivalent circuit of the reactor system of FIG. 1.

FIG. 3 is a schematic of a capacitor-coupled, RF-plasma reactor system with an impedance-transformation circuit in accordance with the present invention.

FIG. 4 is an equivalent circuit of the reactor system of FIG. 3.

FIG. 5 is a graph showing the comparison of the impedance transformation between the conventional circuit of FIG. 2 and circuit with the impedance-transformation circuit of FIG. 4.

### DETAILED DESCRIPTION OF THE INVENTION

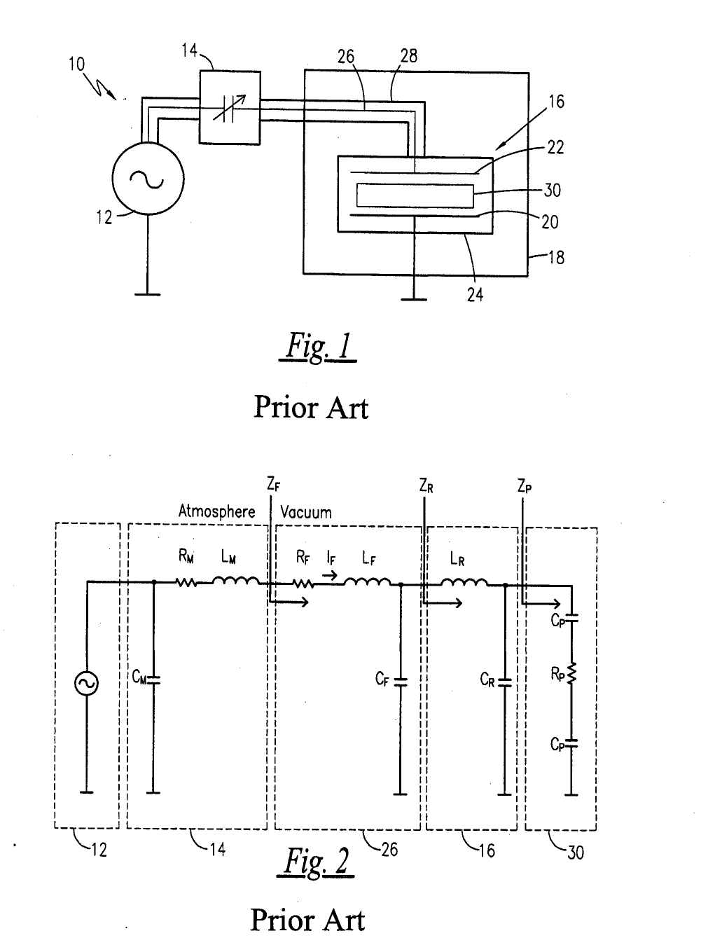

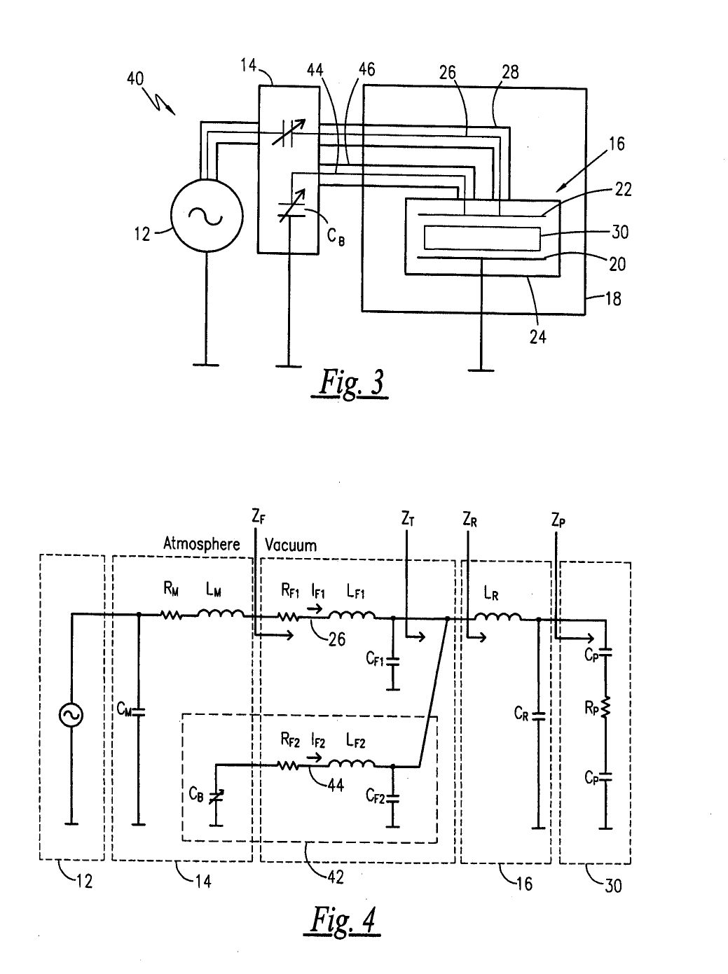

Referring now to FIGS. 3 and 4, a more practical impedance-transformation circuit is shown in the schematic in FIG. 3 and the electrical equivalent circuit in FIG. 4. All components described in FIGS. 1 and 2 above that are the same in FIGS. 3 and 4 will not be repeated.

FIG. 3 shows a capacitively-coupled, RF-plasma reactor system 40 (hereinafter “transformed RF-plasma reactor system”) for a PECVD system having an impedance-transformation circuit 42, shown in FIG. 4, in accordance with the present invention. The impedance-transformation circuit 42 includes a transformation circuit feeding element 44 with a grounding shield 46 and a tuneable-blocking capacitor C_{BT}.

Referring to FIG. 4, the second feeding element 44 is represented in the equivalent circuit as having parasitic capacitance C_{T}, a lossy element R_{T}, and an low-loss inductor L_{T}. The transformation circuit feeding element 44 is located inside the vacuum chamber 18 and is connected to ground via the tuneable-blocking capacitor C_{BT}. Thus, with the addition of the impedance-transformation circuit 42, the transformed RF-plasma reactor system 40 now includes the feeding element 26 and the transformation circuit feeding element 44 both of which are electrically connected to the first metallic plate 22. The tuneable-blocking capacitor C_{BT} is located outside the vacuum chamber 18 and can be integrated into the matching network 14, resulting in amended matching network 14′ (FIG. 3). The tuneable-blocking capacitor C_{BT} can increase the feed-through impedance Re(Z_{F}′) thereby decreasing the total RF current I_{F}′ during the deposition process. Further, the tuneable-blocking capacitor C_{BT} can balance the current between the two feeding elements 26, 44 without venting the system.

The following equations illustrate the effect of the impedance-transformation circuit 42 relating to power loss. First, in the conventional RF plasma reactor system 10, the current I_{F} flowing out of the matching network 14 and through the feeding element 26 with no impedance-transformation circuit 42, as shown in FIGS. 1 and 2, is approximately:
I_{F}=sqrt[P_{F}/Re(Z_{F})] (1)
for an RF signal having a wavelength greater than the diameter of the electrode or longer than the feeding line and where P_{F} is the power at the output of the matching network 14, which is dissipated through the lossy elements R_{M} and R_{P} in the feeding element 26 and the plasma. The power lost through the lossy elements R_{M} and R_{F} in the matching network 14 and feeding element 26 is defined by the following equation:
P_{Loss1}=I_{F}²(R_{M}+R_{F}) (2)
The efficiency of the matching network 14 is defined by:
η_{MB}=Re(Z_{F})/[Re(Z_{F})+R_{M}] (3)
Further, the efficiency of an L-type or T-type matching network is given through:
η=Q_{U}/(Q_{U}+Q_{L}) (4)
where Q_{U} is the unloaded quality factor of lumped elements and Q_{L} is the loaded quality factor of the lumped elements.

With the addition of the impedance-transformation circuit 42, as shown in FIGS. 3 and 4, the current I_{F}′ flowing out of the matching network 14 and through the feeding element 26 is partially compensated by the current I_{T} flowing through the transformation circuit element 44 and tuneable-blocking capacitor C_{BT}. The optimal balance between I_{F}′ and I_{T} can be adjusted through the tuneable-blocking capacitor C_{BT} and depends on the balance between the power losses of the lossy elements (R_{F}′+R_{M}) of the feeding element 26 and matching network 14 and the lossy element R_{T} of the transformation circuit feeding element 44. The total losses in the matching network 14 and the feeding element 26 and transformation circuit feeding element 44 is defined as:
P_{Loss2}=I_{F}′²(R_{M}+R_{F}′)+I_{T}²R_{T} (5)
for an RF signal having a wavelength greater than the diameter of the electrode or longer than the feeding line. If the tuneable-blocking capacitor C_{BT} is adjusted such that the currents I_{F}′, I_{T} are equal then I_{F}′=I_{T}=I_{F}/2. Further, if the currents I_{F}′, I_{T} are equal and if the lossy elements R_{M}, R_{F}′, R_{T}, and R_{F} are also equal, thus, R_{M}=R_{F}′=R_{T}=R_{F}. Thus, if I_{F}′, I_{T} are equal P_{Loss1} becomes:
P_{Loss1}=I_{F}²(R_{M}+R_{F})=2I_{F}²R_{F} (6)
and P_{Loss2} becomes:
P_{Loss2}=I_{F}′²(R_{M}+R_{F}′)+I_{T}²R_{T}=(3/4)I_{F}²R_{F}. (7)
Thus, the loss ratio between the conventional RF-plasma reactor system 10 (no impedance-transformation circuit 42) and the transformed RF-plasma reactor system 40 with the impedance-transformation circuit 42 is:
P_{Loss1}/P_{Loss2}=(2I_{F}²R_{F})/(3/4)I_{F}²R_{F}=8/3. (6)
As these equations illustrate, the power lost through the lossy elements R_{M}, R_{F} in the conventional RF-plasma reactor system 10 (no impedance-transformation circuit 42) are more than twice as much as the power lost through the lossy elements R_{M} R_{F}′, R_{T} in the transformed RF-plasma reactor system 40 with the impedance-transformation circuit 42. Thus, because the power loss decreases in the transformed RF-plasma reactor system 40 with the impedance-transformation circuit 42, the power delivered to the plasma to maintain the same deposition rate as the conventional RF-plasma reactor system 10 (no impedance-transformation circuit 42) can be reduced. Thus, a smaller RF power supply can be used to achieve the same deposition rate. On the other hand, if the same size RF power supply is used the deposition rate will increase thereby increasing throughput.

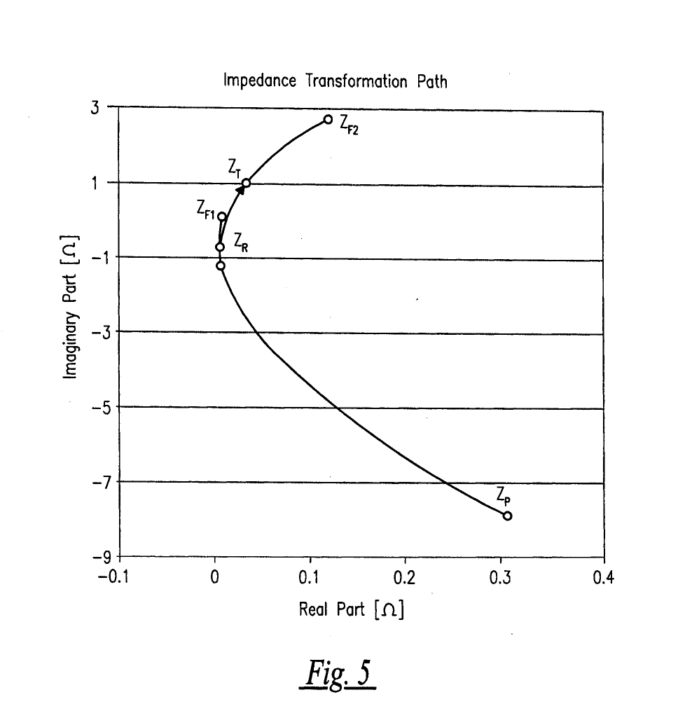

FIG. 5 shows a graph that illustrates how the impedance-transformation circuit 42 transforms the feed-through impedance Re(Z_{F}′) to thereby decrease the power lost through the lossy elements. In the conventional RF-plasma reactor system 10 the plasma impedance Z_{P} is transformed by a reactor capacitance C_{R} and a reactor inductance L_{R} to a reactor impedance Z_{R} located at the end of the feeding element 26. The feeding element 26 then transforms the reactor impedance Z_{R} to a feed-through impedance designated as Z_{F}. In the transformed RF-plasma reactor system 40 the plasma impedance Z_{P} is transformed to the reactor impedance Z_{R} just as in the conventional RF-plasma reactor system 10. The impedance-transformation circuit 42, however, transforms the reactor impedance Z_{R} to an intermediate impedance Z_{R}′. The feeding element 26 then transforms the intermediate impedance Z_{R}′ to a feed-through impedance designated as Z_{F}′. As illustrated in FIG. 5, the feed-through impedance Z_{F}′ has both a higher resistive or real part and a higher inductive reactive or imaginary part than the feed-through impedance Z_{F}. In other words, Re(Z_{F}′)>Re(Z_{F}) and Im(Z_{F}′)>Im(Z_{F}). More specifically, the real part of the feed-through impedance Re(Z_{F}′) is approximately 0.1 to 0.2 ohms whereas the real part of the feed-through impedance Re(Z_{F}) is approximately 0.0 to 0.1 ohms. The imaginary part of the feed-through impedance Im(Z_{F}′) is approximately 1 to 5 ohms whereas the imaginary part of the feed-through impedance Im(Z_{F}) is approximately −3 to 1 ohms. Further, the impedance-transformation circuit 42 is not intended to compensate for reactive impedance or cancel out phase shifts. The more inductive the feed-through impedance Z_{F}, however, the less inductance is required in the matching network. As a result, the quality of the matching network can be enhanced even more because the RF power losses are mainly associated with lumped elements such as inductors made from copper.

While specific embodiments of the invention have been described and illustrated, it is to be understood that these embodiments are provided by way of example only and that the invention is not to be construed as being limited thereto but only by proper scope of the following claims.

1. An RF plasma reactor comprising:
a vacuum chamber (18);
an RF power supply (12);
a matching network (14);
a first metallic plate (22) and a second metallic plate (20) located inside the vacuum chamber;
a plasma-discharge region (30) defined between the first and second metallic plates; a feeding element (26) electrically connected to the first metallic plate (22), the matching network (14) and the RF power supply (12); and,
an impedance-transformation circuit (42) electrically connected to the first metallic plate (22).

2. The plasma reactor of claim 1, wherein, the impedance transformation circuit (42) comprises a transformation circuits feeding element (44) electrically connected to the first metallic plate (22) and a blocking-tuneable capacitor electrically connected to ground.

3. The plasma reactor of claims 1 further comprising a reactor chamber (24), having a reactor impedance, located inside the vacuum chamber (18), wherein the impedance-transformation circuit (42) comprises a low-loss inductor and transforms the reactor impedance to an intermediate impedance,
wherein the feeding element (26) transforms the intermediate impedance to a feed through impedance, and,
whereby the feed-through impedance is increased.

4. The plasma reactor according to claims 1, wherein the first metallic plate (22) is electrically connected to an RF power supply (12), the second metallic plate (20) is electrically connected to ground, and the impedance-transformation circuit (42) is electrically connected to ground.

5. The plasma reactor according to claims 1, wherein the matching network (14) is located outside the vacuum chamber (18) and electrically connected to the feeding element, wherein the blocking-tuneable capacitor is located inside the matching network (14′).

6. The plasma reactor according to claims 1, wherein the feeding element (26) and the transformation circuit feeding element (44) are located inside the vacuum chamber.

7. The plasma reactor according to claims 1, wherein the plasma reactor is an RF-PECVD plasma reactor.

8. An RF plasma reactor comprising:
a vacuum chamber (18);
an RF power supply (12);
a matching network (14);
a first metallic plate (22) and a second metallic plate (20) located inside the vacuum chamber;
a plasma-discharge region (30) for containing plasma defined between the first and second metallic plates;
a feeding element (26) electrically connected to the first metallic plate (22), the matching network (14) and the RF power supply (12) and
an impedance-transformation circuit (42) electrically connected to the first metallic plate (22), comprising a blocking capacitor.

9. The plasma reactor of claim 8 further comprising reactor chamber (16), having a reactor impedance, located inside the vacuum chamber;
wherein the impedance-transformation circuit (42) is a low-loss inductor and transforms the reactor impedance to an intermediate impedance.
wherein the feeding element (26) transforms the intermediate impedance to a feed-through impedance, and,
whereby the feed-through impedance is increased.

10. The plasma reactor of claim 8, wherein the impedance-transformation circuit (42) comprises a transformation circuit feeding element (44) electrically connected to the first metallic plate (22) and a blocking capacitor electrically connected to ground.

11. The plasma reactor of claims 8, wherein the capacitor is a blocking-tuneable capacitor.

12. The plasma reactor according to claims 8, wherein the feeding element (26) is electrically connected to an RF power supply (12) and the transformation circuit feeding element (44) is electrically connected to ground and the second metallic plate (20) is electrically connected to ground.

13. The plasma reactor according to claims 8, wherein the matching network (14′) is located outside the vacuum chamber and electrically connected to the feeding element (26), wherein the blocking-tuneable capacitor is located inside the matching network.

14. The plasma reactor of claim according to claims 8, wherein the feeding element (26) and the transformation circuit feeding element (44) are located inside the vacuum chamber (18).

15. A method of depositing semi-conductive layers in a vacuum comprising the steps of: providing a plasma reactor with an RF power supply (12), a vacuum chamber (18), a matching network (14), a reactor chamber (16), having a reactor impedance, located inside the vacuum chamber, a first (22) and second (20) metallic plate located inside the vacuum chamber; a plasma-discharge region (30) for containing plasma defined between the first and second metallic plates, a feeding, element (26) electrically connected to the first metallic plate (22), and an impedance-transformation circuit (42) electrically connected to the first metallic plate (22);
placing a substrate on the second metallic plate (20);
delivering RF power to the plasma;
transforming the reactor impedance to an intermediate impedance with the impedance-transformation circuit (42); and,
transforming the intermediate impedance to a feed-through impedance with the feeding element (26), whereby the feed-through impedance is increased.

16. The method of claim 15, further comprising the step of depositing a thin film on to the substrate.

17. The method of claims 15, wherein the impedance-transformation circuit (42) comprises a transformation circuit feeding element (44) electrically connected to the first metallic plate (22) and a blocking-tuneable capacitor electrically connected to ground.

18. The method according to claims 15, wherein the blocking-tuneable capacitor is located inside the matching network (14′).

19. The method according to claims 15, wherein the feeding element (26) and the transformation circuit feeding element (44) are located inside the vacuum chamber (18).
